(19) United States
(12) Patent Application Publication
(10) Pub. No.: US 2011/0179921 A1
(43) Pub. Date: Jul. 28, 2011

(54) Method for Processing Domestic and Industrial Fabric Waste

(76) Inventor: Dmitry V. Karlin, St. Petersburg (RU)

(21) Appl. No.: 12/952,681

(22) Filed: Nov. 23, 2010

(30) Foreign Application Priority Data
Dec. 4, 2009 (RU) 2009145976

(51) Int. Cl. B26D 3/00

(52) U.S. Cl. 83/13

(57) ABSTRACT

The invention relates to light industry and can be used for processing previously used textile articles, in particular second-hand articles. Textile waste is selected and materials suitable for secondary use are chosen therefrom. As materials suitable for secondary use there are selected textile articles of one type, the selection being carried out in an amount suitable for industrial processing. The aforementioned textile articles contain at least one standard composite element suitable for forming an overlay and in accordance with which a pattern cutting card is created. An overlay of the standard composite element is formed in accordance with the card, at least one pattern of the article being manufactured is selected for the overlay according to the pattern cutting card, the pattern is positioned on the upper layer of the overlay and the overlay is then cut out so as to obtain the parts of the article being manufactured. The technical result is a reduction in the amount of secondary textile waste sent for disposal or subjected to chemical, thermal and other types of processing, a reduction in labour costs, and achievement of a high productivity.

### CROSS REFERENCE TO RELATED APPLICATIONS

This application claims priority to Russian Patent Application No. 2009145976 filed on Dec. 4, 2009, which is incorporated herein by reference in its entirety.

### FIELD OF THE INVENTION

The invention relates to light industry and can be used for processing previously used textile articles, in particular second-hand articles (second-hand clothing graders).

### BACKGROUND OF THE INVENTION

It is known that textile waste resources, which are a secondary raw material and are suitable for processing, are available in fairly large amounts. Secondary textile raw material is waste formed in the processing of raw material of the textile industry during the cutting and fabrication of sewn and knitted articles, as well as consumption waste in the form of worn-out articles unsuitable for use according to their intended application, but suitable, after appropriate treatment, for use as industrial and domestic products: yarn, thread, furniture, technical and mattress wadding, furniture sheet wadding, nonwoven materials, stuffed and padded materials, etc. All of this can be used in the manufacture of outer garments, in the production of furniture, filled coverings, soft children's toys, mattresses, etc.

Various types of textile material waste exist, including mainly production waste in the form of fibres, yarn, thread, rags and off-cuts of textile materials, and also consumption waste in the form of domestic worn-out textile articles (so-called second-hand articles). Some of these forms can be processed in the same plants where they were manufactured, with the formation of a basic or additional product. Other forms of textile waste that cannot be processed in the same plants where they were manufactured are sent to special factories for processing the secondary raw material. They are processed in these factories, after disinfection and comminution (cutting up) operations, into nonwoven materials for a different use or into a simpler product in terms of manufacturing technology, in the form of fibre packing, furniture and technical wadding, and wadding for wiping and swabbing purposes, etc.

Used clothing and domestic textiles are classed as pure waste, the secondary processing of which does not require any additional operations involving chemical or biological preparation (disinfection), and accordingly the recycling technology is ecologically clean.

The problem of recycling secondary textile raw material has become one of the most urgent problems in recent years, and in particular has received the attention of leading scientific centres involved in the problem of textile production. Various technologies for recycling textile waste exist, the most popular of which is the technology of mechanical combing, separation or comminution of waste. The technology of mechanical recycling of secondary textile raw material includes, as a rule, the operations of sorting and comminution (cutting) the material followed by its processing to obtain elementary fibres, roving or yarn and thread, nonwoven articles and other products.

A production line intended for the realization of a method for regenerating waste is known and described for example in Patent No. 75661 (published 20, Aug. 2008), according to which flat textile material waste (fabric and cloth rags, knitted articles, nonwoven linens) is separated and regenerated. The arrangement according to the aforementioned patent carries out processing of textile waste so as to obtain a fibre-type raw material as end product, which is then further used in the production of textile articles. In other words, the aforementioned technical solution is aimed at improving a mechanical method of recycling by modifying the existing plant. In order to implement the aforementioned technology, fairly complicated equipment is used, described in the patent, and in addition the technology is basically aimed at processing textile waste with a high degree of wear and obtaining a fibrous raw material as end product. Other technologies for processing secondary textile raw material also exist. Such other technologies include, for example, methods of chemical or thermal processing. For example, the technology of processing textile waste by the thermal splicing method envisages obtaining nonwoven fabrics as end product and includes the following process stages:
preparation of textile waste from natural fibres;
preparation of textile waste from thermoplastic fibres;
forming and compaction of canvas and sackcloth;
structuring and compaction of canvas and sackcloth;
splicing of canvas and sackcloth in a heat-treatment machine;
cutting off selvage and packing.

The choice of technology for processing textile waste depends above all on the structure of the waste being processed, and its raw material composition. However, the aforementioned technologies are multi-stage and labour-intensive, and some stages are regarded as hazardous. A “Method for preparing domestic and industrial waste with the selection of components suitable for secondary use” is known according to U.S. Pat. No. 2,165,879 (published 27, Apr. 2001). In accordance with this method the collection of waste is carried out at one site, including the sorting and recovery of components suitable for secondary use and the separation of components unsuitable for further utilization. The sorting includes preliminary manual sorting, which effects separation of waste into materials suitable for secondary use, which are then sent for secondary use. However, the said method is most efficient in the overall provision and servicing of plants with industrial waste, including polymer waste and fibres, and is not intended for processing second-hand articles. Furthermore, the method performs only part of the technology for processing waste and does not include the stage of the secondary use of waste, in particular the stage of processing secondary textiles articles. For secondary use the prepared waste is sent to other enterprises for further processing.

### SUMMARY OF THE INVENTION

The object of the present invention is to develop a method for processing domestic and industrial secondary textile waste, aimed at an overall processing of textile articles, in particular second-hand articles.

This object is achieved in that in a method for utilizing domestic and industrial waste, including the collection of textile waste and separating from it materials suitable for secondary use, there are selected as materials suitable for secondary use textile articles of one type, this selection being carried until an amount is obtained that is suitable for industrial processing. The aforementioned textile articles contain at least one standard composite element, suitable for forming an overlay and in accordance with which a pattern cutting card is created. The overlay is formed according to the elaborated card from the standard composite element, for which there is selected, according to the cutting card, at least one pattern of the article being produced. The pattern is positioned on the upper layer of the overlay and the overlay is then cut out to obtain parts of the article being produced.

The parts of the article being produced can then be cut out by using a suitable press, or by using a laser cutting system.

In the implementation of the proposed method a reduction is achieved in the amount of secondary textile waste, which can be sent for disposal, combustion, or processing using complex industrial operations (combing, separating out of fibres, etc.) and hazardous (chemical, thermal) processing stages. The sale of second-hand articles in special shops also does not completely solve the problems of dealing with these articles. The proposed method is economically advantageous and ecologically safe.

Furthermore, the proposed method ensures a reduction in the use of labour as a result of the overall processing of the secondary textile articles, and more specifically of second-hand articles, starting from the execution of the sorting operations and finishing with the cutting out and sewing of the articles, in one enterprise, and also provides a high productivity due to the forming and cutting out of the overlay consisting of a plurality of layers of articles of a uniform type or parts thereof, as well as the efficient allocation of patterns on the upper layer of the overlay. It is known that textile articles with a minimum degree of wear and tear cannot be realized like clothing, due to the fact that they have been obtained from fashion outlets, or for other reasons, and are stored in 5 suppliers' warehouses in amounts suitable for industrial processing. Such previously used articles, which are classified according to the retail nomenclature of external economic activity by the code 6309000000 (previously used clothing), are sorted for secondary use according to the type of article, size, style and composition of the fabric. A standard composite element is selected from articles of identical style, size and fabric composition. A standard composite element is for example a sleeve or back of a sweatshirt, the front or rear part of for example a skirt, etc. A pattern cutting card—a technological document containing a program and instructions for making the overlay of part of the material (for example the number of standard elements the overlay) and the actual cutting-out data—is compiled according to a standard element. The forming of the pattern cutting card is carried out taking into account the texture of the material, dimensions of the standard composite element, number of sets being cut out, and other parameters. A multilayer overlay is formed for each standard element. The overlays can be formed from whole single-type parts, as well as from parts of single-type articles, for example from sleeves or backs of shirts of identical size. In this way there is basically formed a new raw material base for cutting out new parts of sewn articles. The choice of patterns and their positioning on the upper layer of the overlay is carried out taking account of the shape and dimensions of the overlay, i.e. taking account of the data specified in the pattern cutting card for the given overlay. As a result parts are obtained for fabricating new sewn articles from second-hand articles, having a sufficiently low cost price, wherein the quality of the obtained articles, basically for domestic use, satisfies market requirements.

### BRIEF DESCRIPTION OF THE DRAWINGS

The essence of the invention and the possibility of its industrial application are explained by the example of a specific embodiment, which is illustrated in FIGS. 1-5.

FIGS. 1, 2, 3 show various ways of obtaining a standard composite element from different types of textile articles.

FIG. 1 shows the procedure for cutting out a standard composite element 1 from the back of a fleece jacket. This standard composite element has dimensions A>46 cm and B<42 cm and is used for forming the overlay.

FIG. 2 illustrates the procedure for cutting out a standard composite element 2—the sleeve of a fleece jacket. This standard composite element has dimensions C (width of the sleeve)>25 cm and D (length of the sleeve)>40 cm and is used for forming the board element.

FIG. 3 shows the procedure for cutting out a standard composite element 3 from the front of a skirt made of a jeans fabric. The overlay for the cutting out is formed from the corresponding elements.

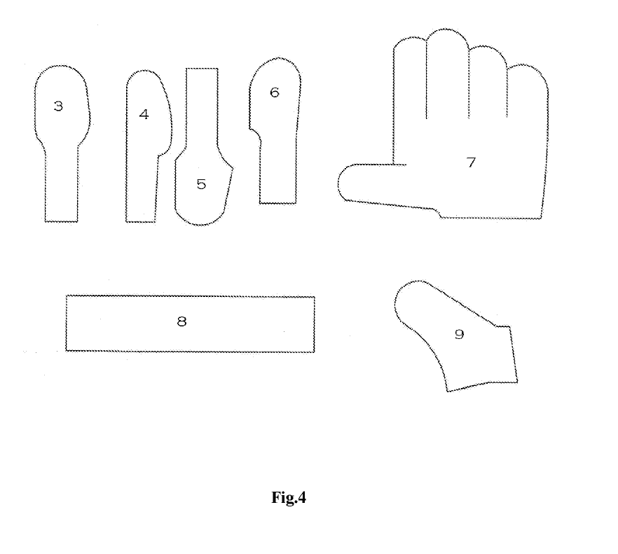

FIG. 4 shows a set of pattern templates for cutting out one article, in the present example a glove (first variant). The set of pattern templates consists of seven parts, and is regulated by the pattern cutting card.

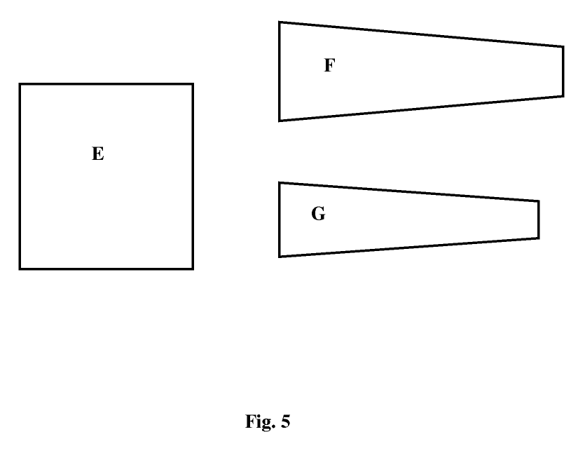

FIG. 5 shows:
a multi-layer overlay E, formed from backs of sweatshirts;
a multi-layer overlay F, formed from sleeves;
a multi-layer overlay G, formed from sleeves of smaller size.

FIG. 6 shows a set of pattern templates for cutting out a glove (second variant). The set of pattern templates consists of three parts, and is regulated by the pattern cutting card.

FIG. 7 shows a glove in the finished state, obtained in accordance with the present invention.

### DETAILED DESCRIPTION OF PREFERRED EMBODIMENTS

The proposed method is carried out in the following way.

From information provided by enterprises involved in sorting second-hand clothing, it is known that stocks of previously manually sorted and packed sweatshirts with long sleeves from adult fleece jackets are stored in such enterprises. At the same time this situation exists throughout the year, with stocks amounting to not less than a container load. Sorting of sweatshirts according to size, colour, etc. is also carried out.

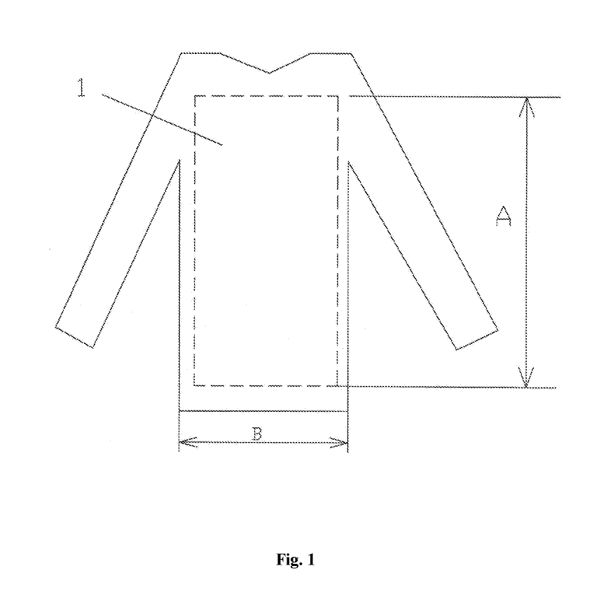

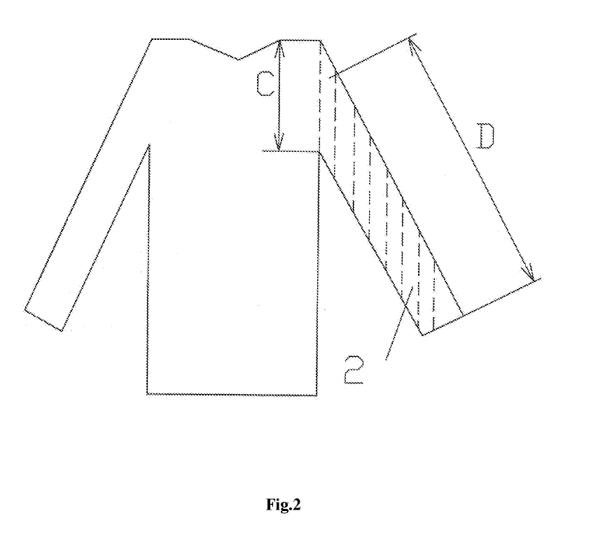

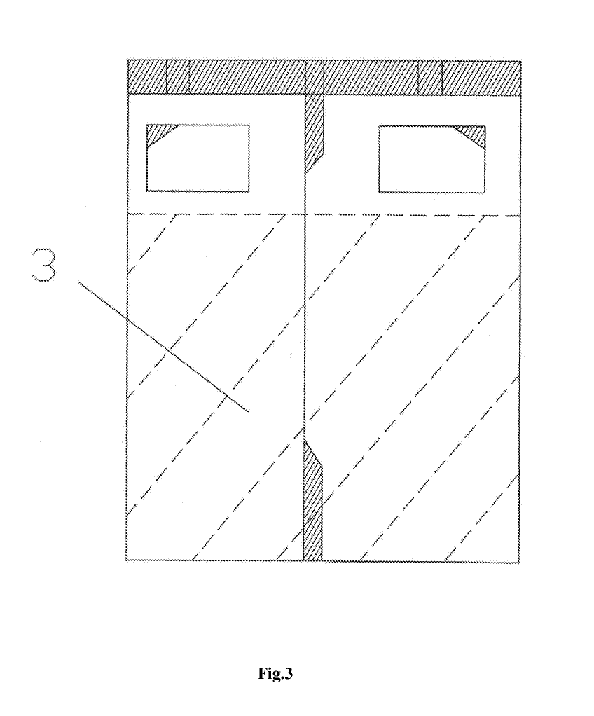

A back or sleeve for example is selected as standard composite element from the sorted sweatshirts (FIGS. 1, 2).

The pattern cutting card is then compiled. Multi-layer overlays are formed from selected standard composite elements in accordance with previously compiled cutting cards (FIG. 5). The overlays are formed as follows:

The overlay E is formed from the standard composite element 1 of backs of sweatshirts and has a size of not less than 42×46 cm, the standard composite element 1 from the back of a sweatshirt being folded four times, 5 thereby forming one layer of overlay. There may be several such layers. In the case of the present example the overlay consists of three layers.

The overlay F is formed from the standard composite 10 element 2 of sleeves of width at the base of not less than 25 cm and length not less than 40 cm. In the present example the overlay F consists of three layers (sleeves).

The overlay G is formed from the standard composite element 2 of sleeves of smaller size, of width at the base less than 25 cm and length less than 40 cm. In the present example the overlay G also consists of three layers.

The decisive factor when forming the fold of the pattern templates of the article being made is the following: the model of the article being made is selected so that its cut-out corresponds as far as possible to the size and shape of the composite standard elements.

The folding of the pattern templates is performed as follows: the pattern template 7 is arranged on the upper layer of the overlay E, the pattern templates 3, 4, 5, 6 and 9 are arranged on the upper layer of the overlay F, and the pattern template 8 is arranged on the upper layer of the overlay G.

The cutting out of the overlays is performed with the aid of a cutting press, for example a PVG8-2-0 press, in one pass of which there are obtained:

from the overlay E—twelve parts 7, from the overlays F and G—six parts 3, 4, 5, 6 and 9 from each as a result a complete cutting-out operation is performed.

The number of layers of the overlays may differ, and is determined in particular by the number of required parts for sewing an article therefrom, as well as by the output of the press and the skill and training of the operator.

The finished parts of the cutting-out operation are passed to the sewing shop, where in particular working gloves are sewn from these parts.

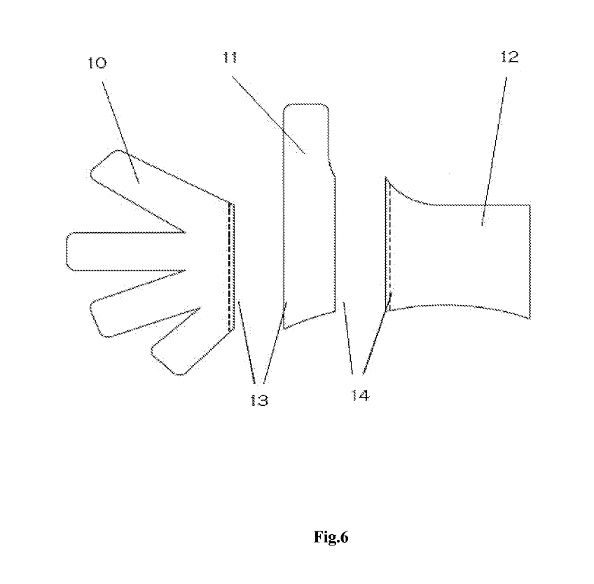

FIG. 6 shows one further variant of carrying out the invention. To form the overlays a set of pattern templates is used for cutting out the glove. The set includes three basic parts: a part 10—the part with entire finger elements for all fingers, except the thumb, and a part 11 formed with a recess for the thumb as a whole, and a part 12—the wrist part.

The overlays are formed as follows:

The overlay E—from a standard composite element 1 of the back of a sweatshirt, which has a size of not less than 42×46 cm, wherein the standard composite element 1 is folded in two, thereby forming one layer of overlay. The part 10 is laid out on the latter so that the stitching line 13 forms an axis of symmetry. Four parts 10 with integral finger elements for all the fingers except the thumb are obtained in the cutting out.

The overlay F is formed from the standard composite element 2 (sleeve of the article), of width at the base not less than 25 cm and length not less than 40 cm. Each element 2 is folded in two along the line so that the two halves are matched along one horizontal edge. As a result there is obtained (in the present example) the overlay F, consisting of two layers (one sleeve). On cutting out, four parts 11 are obtained with a recess for the thumb as a whole, the pattern of this part being folded on the overlay parallel to one another.

The overlay G is formed from the standard composite element 2—the second sleeve of the article. The overlay is formed in four layers, the pattern template 12 being arranged on the upper layer of the overlay G, and four wrist parts are obtained by the cutting out. As a result of such an allocation of patterns a model of the article being produced (pair of gloves) is formed, which is selected on condition that its cutting out corresponds as far as possible to the size and shape of the constituent standard elements.

The cutting out of the overlays is performed using laser equipment.

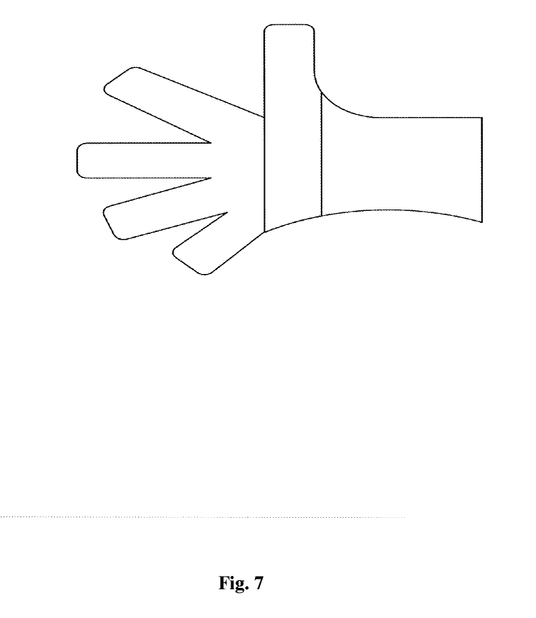

According to the second variant the sewing of the palm or rear part of the glove consists in stitching together the parts 10 and 11 along the stitching line 13, and the parts 11 and 12 along the stitching line 14. The obtained palm and rear parts are superimposed on one another and stitched together with a “zigzag” or interlocking seam. A glove in the finished state is illustrated in FIG. 7.

Accordingly, the proposed technical solution enables articles that are in high demand to be manufactured from secondary textile raw materials, the price of said articles being significantly less and the quality being not inferior to the quality of articles produced from new materials.

### INDUSTRIAL APPLICABILITY

The invention relates to light industry and can be used for processing previously used textile articles, in 5 particular “second-hand” articles (second hand clothing graders). The realization of the technical solution is achieved by means corresponding to the known level of technology. The parts of the article being produced can be cut out by using a suitable press, or by using a 10 laser cutting system.

1. A method of utilizing domestic and industrial waste, comprising:
collecting textile waste;
selecting from the textile waste materials suitable for secondary use,
wherein the selected materials suitable for secondary use are textile articles of a single type,
wherein an amount of the selected materials is sufficient for industrial processing, and
wherein the textile articles comprise at least one standard composite element suitable for forming an overlay;
making a cutting map for the overlay;
forming the overlay with the standard composite element according to the cutting map;
choosing at least one template of a manufactured item according to the cutting map for the overlay;
positioning the template on an upper layer of the overlay; and
cutting the overlay to produce parts of the manufactured item.

2. The method of claim 1, wherein the cutting is performed using a cutting press.

3. The method of claim 1, wherein the cutting is performed using a laser beam.
